(19) United States
(12) Patent Application Publication
(10) Pub. No.: US 2004/0262929 A1
(43) Pub. Date: Dec. 30, 2004

(54) Window lock for a sash window assembly

(75) Inventor: Lyn O. Trickel, Haltom City, TX (US)

Correspondence Address: Thomas E. Sisson, JACKSON WALKER L.L.P., Suite 2100, 112 E. Pecan Street, San Antonio, TX, 78205, US

(73) Assignee: Atrium Companies, Inc.

(21) Appl. No.: 10/867,370

(22) Filed: Jun. 14, 2004

Related U.S. Application Data
(60) Provisional application No. 60/482,814, filed on Jun. 26, 2003.

(51) Int. Cl. E05D 15/22

(52) U.S. Cl. 292/241

(57) ABSTRACT

The sash window assembly includes an upper sash window and a lower sash window. Each of these windows are mounted within opposed guide rails on a master frame. At least one of the windows is slidable within the frame relative to the other window. The window latch system includes a locking assembly for mounting on one side of the sash window. The locking assembly is designed to engage a keeper on the adjacent side of the other sash window. The locking assembly includes a housing having an extended hollow central shaft, an actuator arm, and a cam having a latching blade for engaging the keeper. Alignment pins or tabs are located on the bottom of the housing. A single retaining screw extends through the extended hollow central shaft and secures the housing to the window.

This invention claims priority from provisional application 60/482,814 filed Jun. 26, 2003.

### BACKGROUND OF THE INVENTION

1. Field of the Invention

Applicant's invention relates to the field of window latches or locks. More particularly, the present invention relates to the field of window latches for selectively locking a first window sash against movement relative to an adjacent second window sash.

2. Background of the Invention

Double-hung windows are one of the most common kinds of windows for building structures. Typically, a double-hung window assembly consists of a window frame and a pair of window sashes. The lower sash resides immediately inward of the upper sash so that the sashes overlap and vertically slide parallel to one another along guide rails of the master window jamb of the window assembly.

Most double-hung windows include a locking mechanism located at the point where the sashes meet when the window assembly is closed. A latch mechanism is generally fixed on the header of the lower sash with several fasteners and the corresponding latch-receiving mechanism or keeper is fixed on the sill of the other sash. When the window sashes are in the closed position, the latch may be secured to prevent any movement of the sashes.

Various arrangements have been proposed for selectively locking a first window sash against movement relative to an adjacent second window sash. Some patents which are prior art to this invention include U.S. Pat. Nos. 5,582,445; 5,741,032; 5,492,377; 6,116,665; 6,142,541; 6,568,723; and RE35463. However, none of these patents disclose a window latch system having a single screw which serves to secure the lock to the window and also acts as the pivot point for the latching cam.

### SUMMARY OF THE INVENTION

The present invention provides a window latch system for sliding window assembly having a first and a second sash. The latch system utilizes a single fastener screw to attach the latch to one of the sashes and to provide the pivot axis about which the latch arm rotates. The attaching fastener screw passes through an extended flared collar which terminates approximately 0.005″ above the upper sash surface. The sliding window may be a sash window or may be a horizontally sliding window. The invention will be described for a sash window but the horizontal window application would be functionally equivalent.

In accordance with the invention, the sash window assembly includes an upper sash window and a lower sash window. Each of these windows are mounted within opposed guide rails on a master frame. At least one of the windows is slidable within the frame relative to the other window. The window latching system includes a latch assembly for mounting on one side of the sash window. The latch assembly is designed to engage a keeper on the adjacent side of the other sash window. The keeper may be either attached to the other sash window or be manufactured integrally as part of the other sash window. The latch assembly includes an outer housing having an extended hollow central shaft, a latch arm, and a cam boss. The latch arm has a latching blade for engaging the keeper. Alignment pins or tabs are located on the bottom of the housing for proper placement on the sash so as to align with the keeper. A single retaining fastener screw extends through the extended central shaft and secures the latching assembly to the window. The terminal or distal end of the central shaft terminates a mere 0.005″ above the upper surface of the sash to which the latching assembly is affixed. This close tolerance reduces the effect of any upward pull extension or deformation of the sash material as the fastener screw is tightened to the sash.

### BRIEF DESCRIPTION OF THE DRAWINGS

In the drawings, like elements are depicted by like reference numerals. The drawings are briefly described as follows:

FIG. 1 is a front elevation view of the present invention mounted on a lower sash of two-sash window system.

FIG. 1A is an exploded perspective view of the window latch system of the present invention without the fastener screw in the latched or lock position.

FIG. 1B is a detailed perspective view of the latch arm assembly of the present invention.

FIG. 2 is a perspective view of the window latch system of the present invention without the fastener screw in the open or unlock position.

FIG. 3 is a bottom perspective view of the window latch system of the present invention without the fastener screw in the locked position.

FIG. 4 is a bottom plan view of the window latch system of the present invention without the fastener screw showing the structural relationship of the actuator arm to the window lock housing.

FIG. 5 is a side sectional view of the window latch system of the present invention affixed to a sash.

FIG. 6 is a bottom exploded view of the window latch system of the present invention showing the hollow shaft prior to the end being flared to secure the latch arm to the housing.

### DETAILED DESCRIPTION OF THE PREFERRED EMBODIMENT

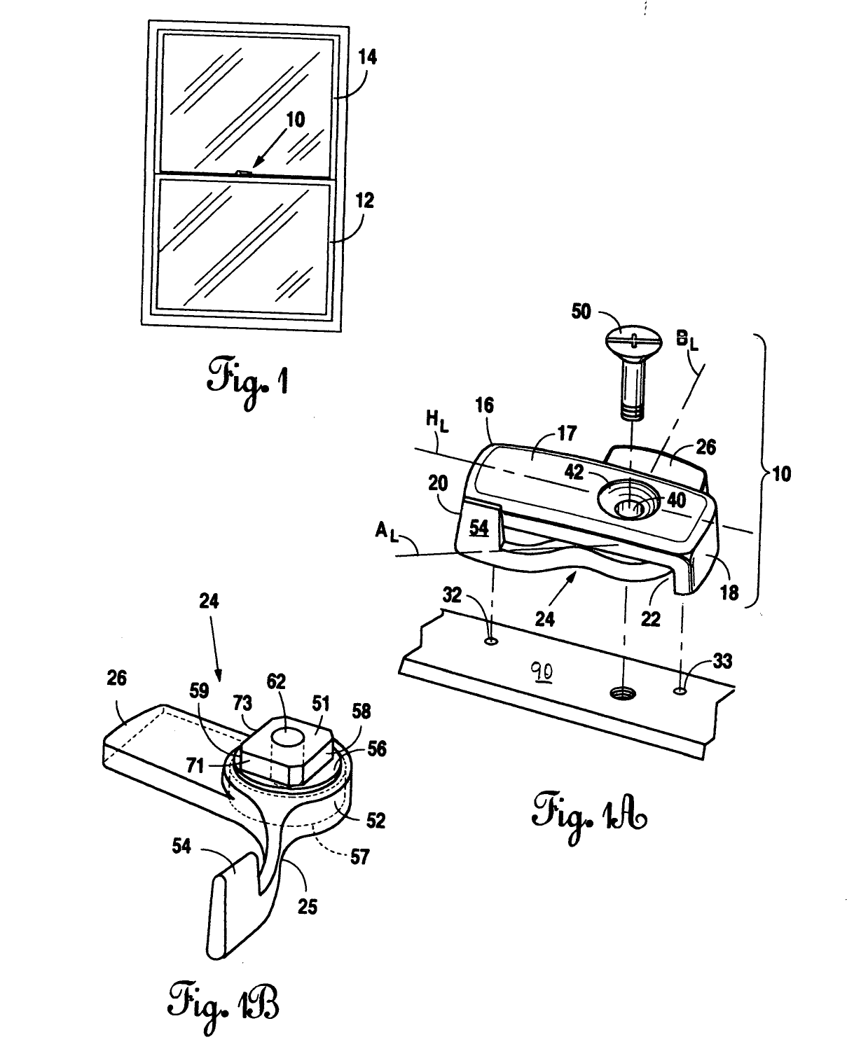

A window latching system for a sliding window is illustrated in the figures. As can be seen in FIG. 1, the window latch 10 may be mounted on a lower window sash 12 such that, when engaged, the window latch 10 will prevent the lower window sash 12 from moving relative to the upper window sash 14.

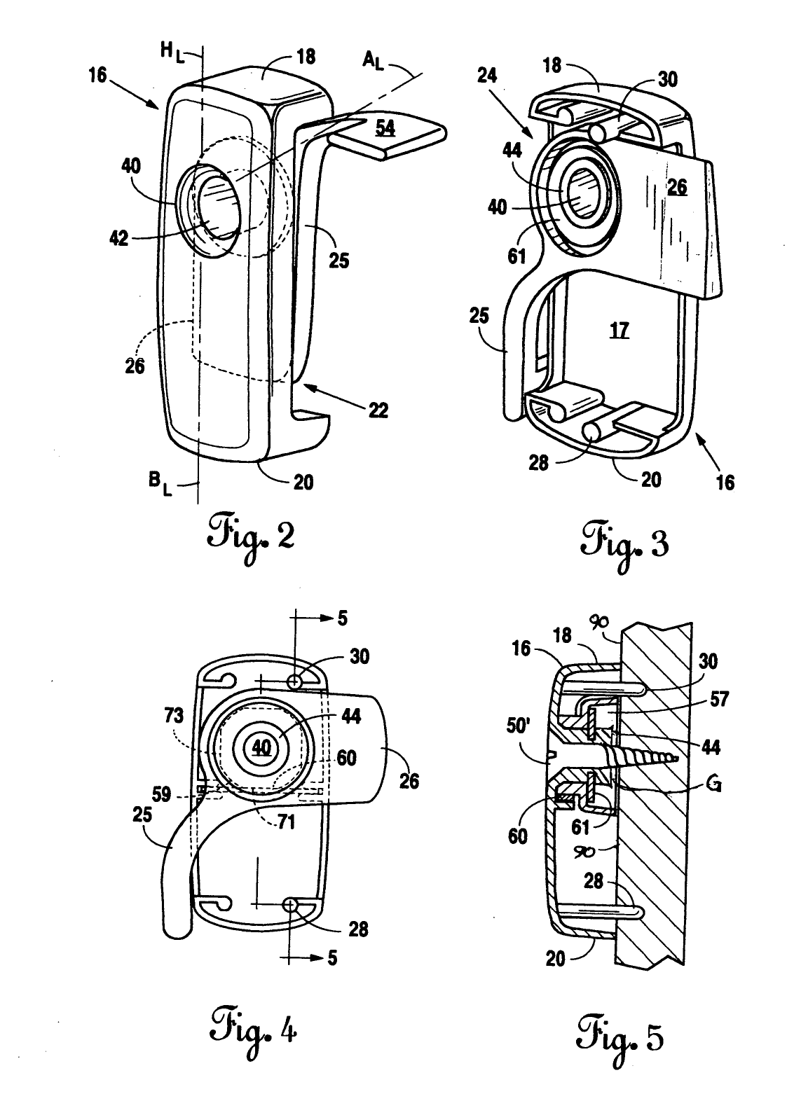

As further may be seen in FIGS. 1A and 2, the window latch system 10 includes an outer window housing 16 having a planar upper wall 17 extending along a longitudinal axis H_{L}. The housing 16 has a pair of opposing side walls 18 and 20 depending downwardly from the upper wall 17. As may be seen, the side walls 18 and 20 cooperate with the upper wall to form an elongated longitudinal slot 22 beneath the upper wall and between the two side walls. As will be understood below, this slot 22 allows the latch arm assembly 24 to move beneath the upper wall when the actuator arm 25 is pushed to position the latch blade 26 in either an opened unlocked or closed locked position.

A pair of opposing alignment legs 28 and 30 depend downwardly from the upper wall adjacent to the sidewalls. The alignment legs 28 and 30 are provided to facilitate proper positioning of the latch system 10 on the sash 12. Corresponding alignment holes 32 and 33 are placed in the sash and are adapted to receive the legs 28 and 30 when the system is secured to the sash.

An extended hollow housing shaft 40 also depends downwardly from a central portion of the upper wall and has a fastener receiving passage 42 extending therethrough. The shaft 40 has a flared end 44 (see FIGS. 3 and 5) which is formed on the distal or terminal end of shaft 40 during the manufacturing process to secure the outer housing 16 to the latch arm assembly 24 as a unit before the insertion of the fastener screw 50 to mount the system 10 on the sash 12. FIG. 6 illustrates the end of the shaft 40 prior to being flared in the manufacturing process. The flared end 44 terminates at a distance of approximately 0.005 inch shorter in length than the length of the opposite side walls 18 and 20 as will be described further below.

The latch arm assembly 24 is shown in more detail in FIG. 1B. It has an upper planar surface 51 and a lower planar surface 52, and a generally flat latch blade 26 or a chamfered leading edge blade (not shown) at a first end. The blade 26 has a longitudinal axis B_{L}. On an opposite end of the assembly, there is an actuator arm 25 having a longitudinal axis A_{L}. Axis is generally perpendicular to axis B_{L}.

An upwardly extending pivot tabs 54 is at one end of the actuator arm to enable the operator to easily pivot the latch arm assembly to and from the opened to the locked position. A raised arm shoulder 56 extends above the blade 26 and supports a generally rectangular cam boss 58 extending above and from the shoulder 56. The cam boss 58 pivots when the latch arm assembly 24 is rotated and provides an edge 59 which urges against a leaf spring 60 FIG. 6 to keep the assembly in either the open or closed position.

A recessed cavity 57 extends from the lower planar surface 52 of the assembly 24 upwardly toward the upper planar surface 51 beneath the cam shoulder 56. As will be noted below, the recess cavity 57 accepts a washer 61 FIG. 6 having a central orifice 63. The washer 61 receives the hollow shaft 40 the housing 16 and is retained in the recess by the flared end 44 of the shaft and between inner shoulder 65 or the upper arm shoulder 58.

FIG. 1B also illustrates that the cam boss 58 has a housing shaft receiving passage 62 extending through the cam boss 58 and the cam shoulder 56 and terminating in the recessed cavity 57. Passage 62 receives and pivotably retains the hollow housing shaft 40.

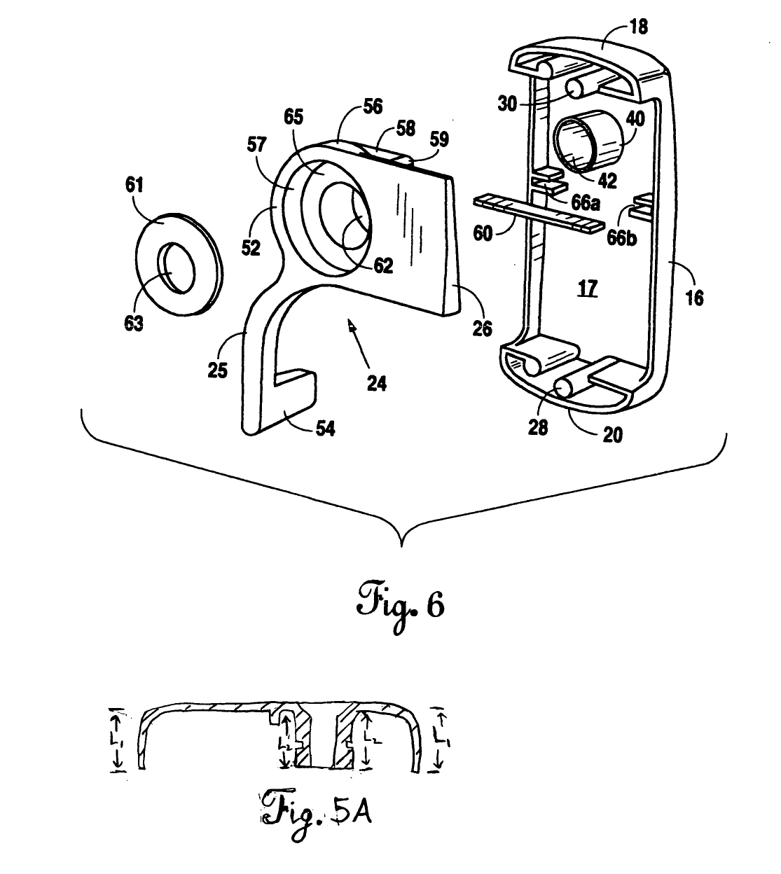

FIGS. 4, 5 and 6 show leaf spring retaining notches 66a and 66b formed in the planar upper wall 17 of the housing 16. Notches 66a and 66b hold the leaf spring in position when the latch arm assembly 24 is pivoted from a first position as the cam boss 56 urges against the spring. As the rectangular boss 56 rotates, the spring 60 bends as the edge or corner 59 passes by the spring. Once the arm assembly 54 gets to the second position the spring bends back to its original straight configuration and holds the assembly in this second position.

The latch system 10 also employs a single fastener screw 50 (see FIG. 1-A) or 50′ (See FIG. 5) which passes through the housing 16 via the fastener receiving passage 42 in the extended hollow housing shaft 40 and through the latch arm assembly 24. The screw 50 engages one of the sashes (for example sash 12) to secure the system 10 to the sash 12. The cam boss 56 is thusly capable of pivoting about the single screw 50 to move the latch blade 26 to move from the open to the locked position.

The distal end of shaft 40 (at the flare 44) is approximately 0.005 inch shorter in length L₂ than the length L₁ of the opposing side walls 18 and 20 (FIG. 5A). This sizing of these elements allows the assembly 10 to be securely affixed to the upper sash surface 90 (FIGS. 1A and 5) with only a 0.005″ gap G (FIG. 5) between the flare 44 and the sash surface 90. As the screw 50 or 50′ is tightened to secure the assembly 10 to the sash 12, there is a tendency for the sash surface to be pulled from its natural resting plane. This is particularly true when the sash material composition is a more malleable metal such as aluminum. The extended shaft 40 terminating only 0.005″ from the sash surface 90 reduces the amount of material deformation ensuring a more secure affixation of the assembly 10 to the sash 12 and less structural damage to the sash surface 90.

As may be seen in FIGS. 1 and 2, when the latch arm assembly 24 is pivoted about the single fastener screw 50, the system 10 moves from a first open position FIG. 2 wherein the blade axis B_{L} is generally parallel to the housing axis H_{L} to a second locked or closed position (FIGS. 1A, 3 and 4) wherein the blade axis B_{L} is perpendicular to the housing axis H_{L}. In the locked position the blade 26 engages the keeper not shown on the second sash to restrict the displacement or sliding of the two sashes relative one another.

A significant advantage of the present invention is that having a single retaining screw through the cam mechanism increases the strength and rigidity of the lock. For example, if the housing would be pried off the window sash, the cam could still stay in place, keeping the window locked. A further benefit is that the present design reduces the manufacturing costs since there is only one screw required. It also reduces the time necessary to properly install the window locks on-site due to the alignment pins and single screw. Other advantages include a more modern look, smaller size, lighter weight, and better alignment.

In the preferred embodiment, the actuator arm and the cam are a unitary piece. The housing actuator arm and cam are made of metal, although they could be made out of durable plastic.

While the specific embodiments have been illustrated and described, numerous modifications come to mind without significantly departing from the spirit of the invention and the scope of protection is only limited by the scope of the company and claims.

What is claimed:

1. A window lock for a sliding window assembly, the sliding window assembly having a first window sash and a second window sash, said second window sash having a latch keeper, said window lock comprising:
a housing having a shaft;
an actuator arm;
a cam having a latching blade at one distal end, said latching blade engageable with said latch keeper on said second window sash;
said shaft extending through said cam and rotatably coupling said arm and said cam to said housing; and
a single retaining screw coupling said window lock to said first window sash.

2. The window lock of claim 1 further comprising alignment pins on the bottom of said housing.

3. The window of claim 1 further comprising a leaf spring engaged with said cam.

4. A window latch system for a window assembly, said window assembly having a first and a second window sash, said window latch comprising:
an outer housing having a hollow housing shaft depending downwardly from a planar upper wall, said shaft having a single fastener receiving passage therethrough for receiving and retaining said single fastener screw;
a latch arm assembly having a cam boss and latch blade, said boss having a central housing shaft receiving passage adapted to rotatably receive said hollow housing shaft, said hollow housing shaft retained in said central housing shaft receiving passage by a flared end portion of said hollow housing shaft; and
a single fastener screw to secure said window latch to one of said sashes when said screw extends through said fastener receiving passage and engages said one of said sashes, said cam pivotable about said fastener screw.

5. The latch system of claim 4 wherein said outer housing has a pair of opposing side walls extending downwardly from said upper side wall for a first length, said hollow housing shaft having a terminal end extending downwardly from said upper side wall for a second length, said second length being less than said first length.

6. The latch system of claim 5 wherein said second length is approximately 0.005″ less than said first length.

7. A window latch system for a sliding window assembly having a first and second window sash, said latch system affixable to one of said sashes by means of a single fastener screw, second window sash having a latch blade keeper, said system comprising:
an outer housing comprising:
a planar upper wall having a longitudinal axis;
a pair of opposing side walls depending downward from said upper wall, said walls cooperating with said upper wall to form an elongated longitudinal slot beneath said upper wall and between said side walls;
a pair of opposing alignment legs depending downward from said upper wall, each of said legs adjacent said side walls;
a hollow housing shaft depending downward from a central portion of said upper wall, said shaft having a fastener receiving passage extending therethrough and a flared second end; and
a pair of spring retaining notches formed in said planar upper wall; and
a latch arm assembly comprising:
an upper planar surface and a lower planar surface;
a flat latch blade at a first end of said assembly, said blade having a longitudinal axis;
an actuator arm at a second end of said assembly, said arm having a longitudinal axis extending generally perpendicular to said blade axis;
said arm having an upward extending pivot tab at one end of said arm;
an upper cam shoulder extending above said blade of said assembly;
a generally rectangular cam boss extending from and above said shoulder;
a recessed cavity extending from said lower planar surface, said cavity beneath said cam shoulder;
a housing shaft receiving passage extending through said cam boss and said shoulder and terminating in said recessed cavity, said housing shaft receiving passage adapted to receive and pivotably retain said hollow housing shaft;
a washer having a central orifice to receive said hollow housing shaft, said flared second end of said housing shaft retaining said washer within said recessed cavity; and
a straight leaf spring adapted to be received and retained in said spring retaining notches, said spring resiliently urging against a first side wall of said cam boss when said latch arm assembly is in a first open position and against a second side wall of said cam boss when said latch arm assembly is in a second position, said spring bendable as said latch arm assembly is pivoted about said single fastener screw from said first portion wherein said blade axis is parallel to said housing longitudinal axis to said second position wherein said blade axis is generally perpendicular to said housing longitudinal axis.

8. A window latch system of claim 7 wherein each of said opposing side walls of said pair extend downwardly from said upper side wall for a first length and said hollow shaft has a terminal end extending downwardly from said upper side wall for a second length, said second length being less than said first length.

9. The latch system of claim 8 wherein said second length is approximately 0.005″ less than said first length.
